(19) United States
(12) Patent Application Publication
(10) Pub. No.: US 2006/0268879 A1
(43) Pub. Date: Nov. 30, 2006

(54) Quality of service aware robust link state routing for mesh networks

(75) Inventors: Ariton Xhafa, Plano, TX (US); Neeraj Poojary, Sunnyvale, CA (US); Shantanu Kangude, Dallas, TX (US); Anuj Batra, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/432,124

(22) Filed: May 11, 2006

Related U.S. Application Data
(60) Provisional application No. 60/680,265, filed on May 11, 2005.

(51) Int. Cl. H04L 12/56

(52) U.S. Cl. 370/392

(57) ABSTRACT

A wireless device for routing data in a mesh network is provided. The wireless device includes a component operable to obtain metrics related to one or more directly adjacent links in the mesh network and metrics received from one or more other nodes in the mesh network. The component is operable to apply parameters that include weighting to one or more of the metrics to compute one or more routes for routing data. The wireless devices also includes a transmitter that is operable to propagate to one or more adjacent nodes in the mesh network routing information related to the parameterized metrics obtained by the component.

### CROSS-REFERENCE TO RELATED APPLICATIONS

This application claims priority to U.S. Provisional Application No. 60/680,265, filed May 11, 2005, entitled “QoS Aware Robust Link State (QARLS) Routing for Mesh Networks”, Ariton Xhafa, et al. inventors, which is incorporated herein by reference for all purposes.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present disclosure is directed to wireless networks, and more particularly, but not by way of limitation, to a method and system for routing traffic through a mesh network.

### BACKGROUND OF THE INVENTION

The ability to access high speed and high performance data networks is becoming increasingly important to data clients. Wireless network access is needed in many areas where wired infrastructure is non-existent, outdated, or impractical. In some environments, wireless broadband networks can perform this function. However, the effectiveness of wireless broadband technology is limited due to a combination of technological constraints and high deployment costs. For example, each conventional Wireless Local Area Network (WLAN) technology access point must be connected directly to a wired backbone infrastructure.

To address the problem of access point tethering, mesh networks have been studied as an alternative. However, the effectiveness of wireless mesh networking is severely limited. In its most basic form, the mesh network is limited by its network capacity due to the requirement that nodes forward each others' packets. This forwarding of packets carries a corresponding increase in data overhead, making the mesh network inefficient. Finding ways to efficiently route traffic to minimize network overhead is, therefore, essential to extending both the efficiency and reliability of mesh networks.

Wireless routing protocols may be classified as table-driven or demand-driven. Table-driven protocols attempt to maintain up-to-date routing information for every node in the network. Each node maintains a routing table which is updated based on topology changes in the immediate neighborhood and routing table updates received from other nodes. Any updates to the routing table are propagated to other nodes in the network.

Demand-driven or source-initiated routing protocols will initiate a route discovery process only when a source node requires a route to a destination. The route discovery process is terminated once a route is found or all possible routes have been examined. Once a route is established, it is maintained by a route maintenance procedure until a route to the destination is no longer desired or the destination node becomes inaccessible.

Table-driven and demand-driven protocols are also referred to as proactive and reactive protocols, respectively. Table-driven protocols provide low latency in route establishment at the expense of high routing overhead in terms of signaling to maintain up-to-date routing information for every node in the network. Conversely, demand-driven protocols have less overhead since routes are established only as needed, but the route establishment latency is high.

### SUMMARY OF THE INVENTION

According to one embodiment, the present disclosure provides a wireless device for routing data in a mesh network. The wireless device includes a component operable to obtain metrics related to one or more directly adjacent links in the mesh network and metrics received from one or more other nodes in the mesh network. The component is operable to apply parameters that include weighting to one or more of the metrics to compute one or more routes for routing data. The wireless devices also includes a transmitter that is operable to propagate to one or more adjacent nodes in the mesh network routing information related to the parameterized metrics obtained by the component.

In another embodiment, the present disclosure provides a method for updating nodes in a mesh network with routing information. The method includes obtaining one or more metrics related to one or more adjacent links in the mesh network. The method includes defining parameters that include weighting the one or more metrics to be used for routing. The method also includes propagating routing information related to the parameterized metrics to one or more adjacent nodes in the mesh network.

In still other embodiments, the present disclosure provides a component used by a wireless mesh point in a mesh network. The component may be circuitry/software/firmware and other such systems operable to execute a routing protocol that includes obtaining metrics for at least some links adjacent to the wireless mesh point. The routing protocol includes obtaining metrics related information for some other links in the mesh network, and publishing at least some of the metrics for the adjacent links to at least some adjacent mesh points. The routing protocol includes applying parameters to weight the metrics for the adjacent links and to weight the metrics related information for some of the other links for routing.

These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 illustrates a mesh network suitable for implementing the embodiments of the present disclosure.

FIG. 2 illustrates relationships between nodes within the mesh network.

FIG. 3 is an exemplary routing table.

FIGS. 4a and 4b are examples of network topologies illustrating different routes that may be taken by network traffic according to embodiments of the present disclosure.

FIG. 5 illustrates an exemplary general purpose computer system suitable for implementing the several embodiments of the disclosure.

### DETAILED DESCRIPTION OF THE PREFERRED EMBODIMENTS

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their full scope of equivalents.

The present disclosure, according to one embodiment, provides a routing protocol for devices in a mesh network. The protocol may include that the nodes or devices obtain quality of service (QoS) metrics about adjacent links. The protocol includes that the nodes parameterize, such as by applying a weighting, the various metrics and use the parameterized metrics to compute routes to enable QoS routing in mesh networks. By parameterizing the metrics, the nodes are able to coordinate, and in some embodiments optimize, the routing information shared with other nodes. The nodes may use or refer to one or more computed routes to route data for QoS purposes.

The quality of service (QoS) metrics may include, but are not limited to bandwidth, signal-to-noise ratio, delay, jitter, hopcount, and so on about adjacent links. The parameters are used to evaluate the metrics to determine desirable routes through the mesh network. The parameters may weight one or more of the metrics, such as signal-to-noise ratio (SNR) and bandwidth, to compute desirable routes based on the requirements for different types of service. The parameters may also include other information such as the extent or amount of source tree information shared or gathered by each node. The set of links used by a node in its “preferred” path to destinations may be referred to as the “source tree” of the node. Different QoS metrics can be associated with the cost link state metric. Using this information, the nodes may compute multiple alternate paths to be used as needed.

Compared to distance vector routing protocol which can only provide link state information for the link to the neighboring node, the present link state routing protocol offers greater flexibility when dealing with QoS traffic and route selection based on QoS because it carries link state information for all the links in the path to the destination. Furthermore, distance vector protocols abstract the metric information on the route, while the present system maintains and shares the granularity on each metric for each link in the path to the destination for use by each node.

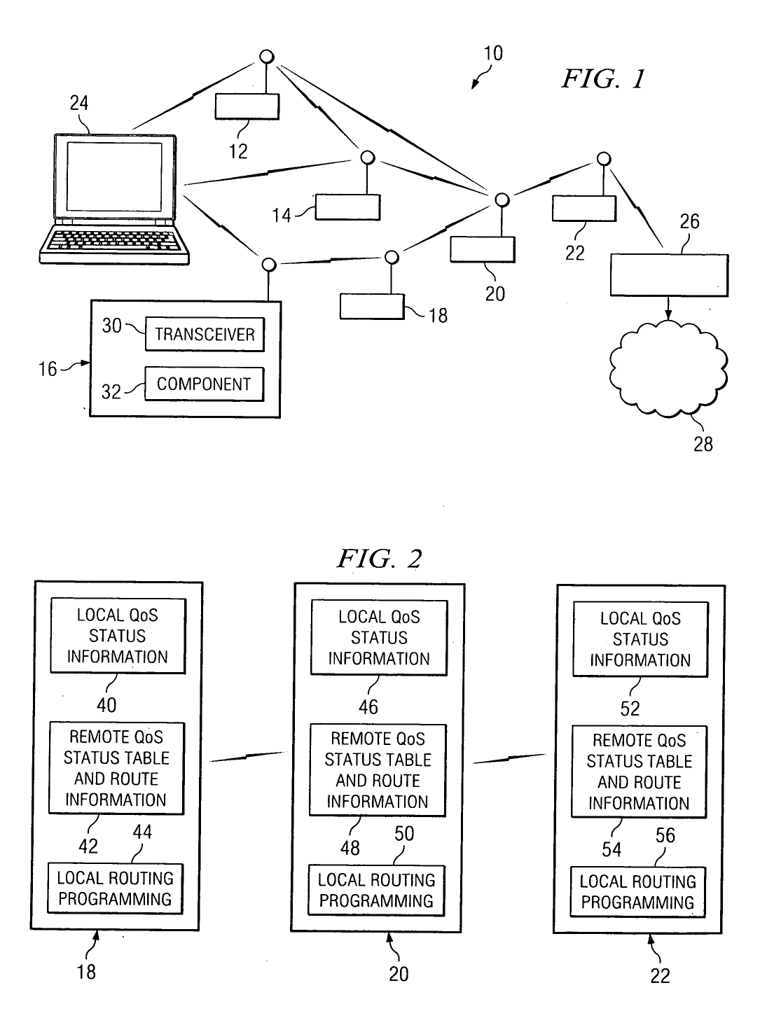

In an embodiment shown in FIG. 1, a mesh network 10 comprises a data source 24, a plurality of nodes, including a first node 18, second node 20, third node 22, fourth node 12, fifth node 14, and sixth node 16, capable of sending, receiving, and routing wireless data, a connection to a terrestrial network node 26, and a wired network 28. In this embodiment, the data source 24 may be a personal computer equipped for wireless data transmission.

The nodes 12-22 and data source 24 are provided for illustration only and the nodes 12-22 as well as the data source 24 may be mesh points, access points, combination mesh/access points, computers, laptop computers, portable computers, servers, routers, mobile handsets, or other systems associated with mesh or access points, or other components commonly deployed in mesh networks. Node 16 includes a transceiver 30 capable of wirelessly sending and receiving data packet and a component 32. Component 32 includes logic which may include or be implemented using one or more processors, circuitry, software, firmware, or systems capable of processing data, instructions, and rules including routing and other protocols. Although only node 16 is shown having the transceiver 30 and component 32, each of the other systems, including nodes 12-22 and data source 24 may have the transceiver and component 32 as well.

The terrestrial network node 26 refers to a node that is connected to a wired network 28. Each node 12, 14, 16, 18, 20, and 22 of the mesh network 10 is programmed, according to embodiments of the present disclosure, to route traffic by using QoS metrics to implement a QoS aware robust routing protocol (QARLS), or other routing protocol. The terrestrial network node 26 may be used to obtain network metrics and parameters determining routing information for input to the plurality of nodes 12, 14, 16, 18, 20, 22, or each of the devices or nodes in the network may gather and share the information individually. As discussed above, QoS data, according to embodiments of the present disclosure, may include network metrics such as signal to noise ratio (SNR), bandwidth delay, buffer space, processing power, and battery power.

In the embodiment illustrated by FIG. 1, data transmission between nodes is possible as indicated by the arrows in FIG. 1. For example, data source 24 is capable of communication with the fourth node 12, fifth node 14, and sixth node 16. In this embodiment, fourth node 12 is capable of communication with data source 24, fifth node 14, and second node 20. A packet data which originates from data source 24 which is directed to wired network 28 may travel through several routes. For instance, a data packet may leave data source 24, travel through the fifth node 14, on to the second node 20, on to the third node 22, finally reaching terrestrial network node 26. The terrestrial network node may be connected to an internet protocol (IP) based network, such as the Internet or an Intranet. An alternative of this route is for data packet to go through the sixth node 16, on to the first node 18, on to the second node 20, on to the third node 22, and then on to terrestrial network node 26. The determination of the most efficient route is made according to embodiments of the present disclosure.

FIG. 2 is an example of one embodiment of the exchange of information for the routing protocol found in several of the nodes 18, 20, and 22 illustrated by FIG. 1. FIG. 2 shows the first node 18 that contains a first local QoS data 40, first remote QoS status table and route information 42, and first local routing programming 44. FIG. 2 also shows the second node 20 that contains a second local QoS data 46, a second remote QoS status table and route information 48, and a second local routing programming 50. A third node 22 contains a third local QoS data 52, a third remote QoS status table and route information 54, and a third local routing programming 56.

The first, second, and third local QoS data 40, 46, and 52 may include link state metrics regarding links adjacent, such as directly adjacent nodes 18, 20, and 22, respectively. The first, second, and third remote QoS status table and route information 42, 48, and 54 may include link state metrics for all the links in the mesh network other than directly adjacent nodes 18, 20, and 22, respectively.

The first local route programming 44, second local route programming 50, and third local route programming 56 may include the parameters, such as weightings for each metric, and the size of the source tree to gather. The local route programming 44, 50, and 56 may also include information needed for computing one or more routes using the parameterized metrics, such as a primary and one or more alternate routes, route selection, and other information to bring QoS awareness to routing in the mesh network. The parameters may also define the information that is to be shared between nodes to coordinate and/or optimize the amount of information needed for QoS routing, while minimizing the traffic and load that the routing information and metrics places on the network. The parameters may include other protocol and routing information or processing that will readily suggest themselves to one skilled in the art in view of the present disclosure, all of which are within the spirit and scope of the present disclosure.

In some embodiments, the first node 18 generates the local QoS status information 40. The first node 18 obtains remote QoS status table and route information from at least one other node, such as the second node 20. The route information obtained from the second node 20 includes connectivity data and metrics regarding which nodes the second node 20 has direct connectivity with. In the example given by FIG. 2, the second node 20 might transmit its local QoS status information 46 to the first node 18 and the third node 22, which is used by nodes 18 and 22 for the remote QoS status table and route information 42 and 54, respectively. In this embodiment, each node advertises a complete source tree to its neighbor. Second node 20 advertises all the links state QoS data currently available to it to all nodes, including the first node 18 and third node 22. This information will include the QoS data with a reference to the relationship of fourth node 12 to data source 24, and fifth node 14.

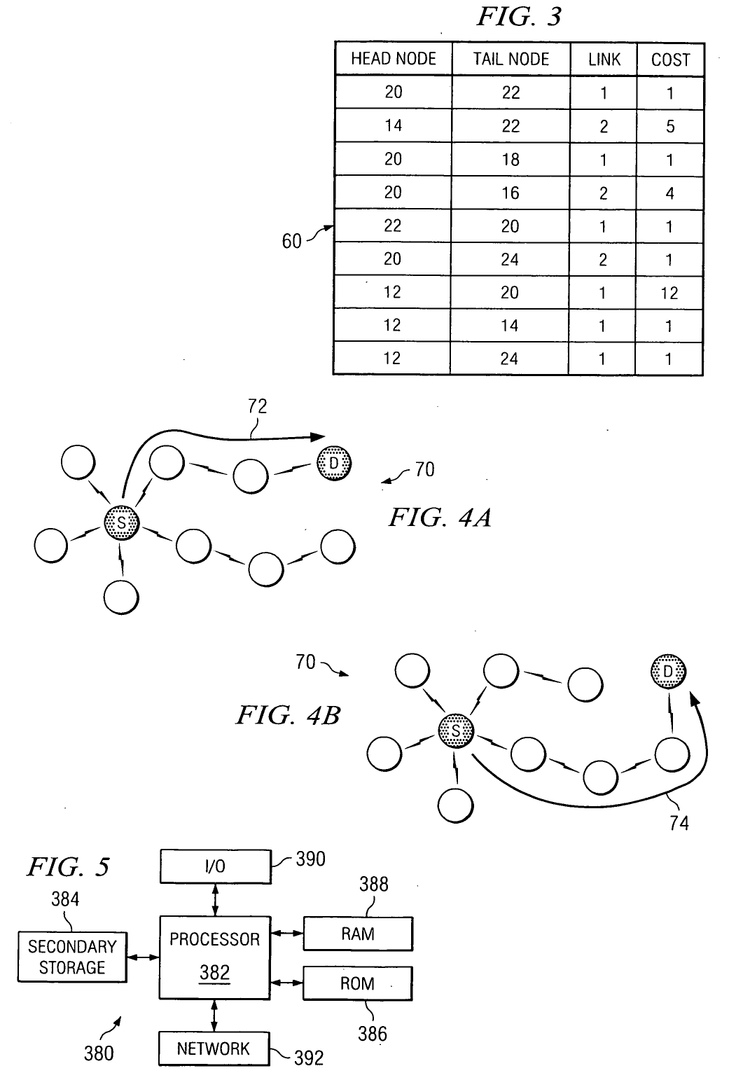

FIG. 3 provides an example of a section of a source tree 60 for part of the mesh network 10. In FIG. 3, the head node corresponds to the sending node, the tail node corresponds to the receiving node, the link corresponds to the relative number of network hops from the head to the tail, and the cost is a value based upon QoS factors. In one embodiment, the cost may be a value that is determined by adding the number of hops from head to tail and multiplying that sum by the network delay along a specific network lag. The cost may be computed in other manners in other embodiments. The QoS information, SNR, bandwidth, and so on might be maintained in the same or other tables, for example.

The one embodiment, routing protocol of the present disclosure is a link state routing (proactive routing) that involves dissemination of information with regard to each and every link to each and every node in the network. In some embodiments, Dijkstra's algorithm is used with the present disclosure to determine the shortest path. Dijkstra's algorithm is an algorithm that solves the single-source shortest path problem and is well known to those skilled in the art. In other embodiments, other systems or algorithms might be used. In other embodiments, the local route programming contained within each node allows for non-optimal or for preferred route selections to overrule QoS considerations.

FIGS. 4a and 4b illustrate a source tree 70, with two possible routes 72, 74 between a source (S) and a destination (D). The present disclosure allows for the route selection between the two routes 72, 74 based on local route programming. When route 72, for example, provides improved QoS as compared with route 74, the source would route the packet according to the route 72. In the event, the environment or conditions changed and delivery of one or more packets were affected, the source, according to the present disclosure, could quickly re-route the packet on the second route 74 which has been pre-computed, without the need to re-evaluate and recalculate routes.

According to one embodiment of the present routing protocol, the topology of a network is modeled as a directed graph G=(V,E), where V is the set of nodes and E is the set of edges connecting the nodes. Each node has a unique identifier and may represent a router. According to the present disclosure, each node maintains a topology of the entire network. In the embodiment of a mesh network, each node maintains a topology of the entire mesh network. Each node reports to its neighbors the characteristics of every link that it uses to reach each known destination. As described above, the set of links used by a node in its “preferred” path to destinations may be referred to as the “source tree” of the node. The preferred path is not necessarily the optimal path from the source to the destination. Therefore, the node does not need to send an update to inform its node neighbors of a change in a route from one that is sub-optimal to one that is optimal. This process minimizes data overhead and maximizes the efficiency of the network.

The update process of network topology data also occurs when multiple routes from the source to the destination are available. A router knows its adjacent links and the source trees reported by its neighbors. As a result, the router knows a “topology graph” of the network. This is useful, especially for multi-route support. The router uses the topology graph to generate its own source tree. Each router derives a routing table specifying the successor to each destination by running a local “route-selection algorithm” on its source tree. Because each router communicates its source tree to its neighbors, the deletion of a link no longer used to reach a given destination is implicit with the addition of the new link used to reach the same destination.

A mesh node will generate a second source tree by running, for example, Dijkstra's algorithm a second time on a subset of its topology graph. Thus, the first run will include the entire topology graph. On a second run, the node will use a subset of the topology graph by removing one or more links based on some criterion, while verifying that the graph is still connected. The second run will generate an alternative source tree which will be stored by the node.

The basic message update used in the communication between nodes is the “link-state update” (LSU). In one embodiment, a single LSU message reports the characteristics of a single link. It is envisioned that in other embodiments, a single LSU message may contain information about several links or even multiple nodes. Routers are able to determine that an LSU contains more recent link-state information for a given link than the information stored locally for the same link by means of sequence numbers. Each router erases a link from its topology graph if the link is not adjacent to the router and the link is not present in the source trees reported by any of its neighbors. LSU messages are exchanged between nodes in update messages. These messages are similar to the messages used to propagate the remote QoS status table and route information illustrated by FIG. 2. The frequency and content of the LSU messages is dependant upon the local route programming and the approach taken to routing traffic. Two examples of possible approaches to routing are the optimal routing approach (ORA) and least overhead routing approach (LORA). In the ORA approach, more information is transmitted through the LSU messages to give the most accurate network topology to the nodes, while in the LORA approach the minimum amount of network topology data is transmitted to minimize network overhead. Thus, according to different embodiments of the present disclosure, the routing protocol can be parameterized to meet specific network demands.

For a LSU for a link (u,v) in an update message with an ordered pair of vertices (u,v) representing a connection from vertex u to vertex v, the variable l represents the cost of the link, and the variable sn which is the sequence number assigned to the LSU. In some embodiments, the data that is transmitted has a set of the four variables (u,v,l,sn). Each node maintains a topology graph, a source tree, a routing table, a list of the neighbors to the node, a local copy of the source trees reported by each neighbor, and a complete topology graph of the entire network. In this example, the phrase entire network is intended to include, but not be limited to, the entire mesh network that the node is part of.

According to one embodiment, the present routing protocol uses sequence numbers to validate LSUs. A sequence number associated with a link consists of a counter that can be incremented only by the head node of the link (for link (u,v) u is the head node). For convenience, a router i needs to keep only a single counter SNi for all of the links for which it is the head node, which simply means that the sequence number a router gives to a link for which it is the head node can be incremented by more than one each time the link parameters change value. A router receiving an LSU accepts the LSU as valid if the received LSU has a larger sequence number than the sequence number of the LSU stored from the same source, or if there is no entry for the link in the topology graph and the LSU is not reporting an infinite cost. This way, routing loops are avoided. Link state information for failed links are the only LSUs erased from the topology graph.

A functional bi-directional link between two nodes has a cost associated with it that can vary in time, but should always positive. To accommodate/support QoS for different traffic streams, the cost associated with the bidirectional link is expressed in terms of QoS metrics. These metrics depend on the type of service supported, e.g. for multimedia QoS metrics might be bandwidth, delay jitter and latency; for emergency service QoS metrics might be network availability. In mesh networks, bandwidth, average packet error rate in the link, battery power (for handhelds), and medium access delay will be some of the QoS metrics that might be needed to support QoS services.

The present disclosure not only creates network topology, but also has the ability to remove connections with the topology. One method for selecting links for removal is to remove the link with the maximum cost that was added to the source tree during the first run of Dijkstra's algorithm. A second step in the execution of Dijkstra's algorithm is to build a list of links that are added to the source tree. This list will be maintained in non-increasing order of the link cost. If removal of the first link will result in an unconnected graph, then the next link in the list is checked to see if it will result in an unconnected graph.

This process may be repeated to remove unnecessary connections from the network topology. Unless the original topology graph is itself a minimum source tree, at least one link in the primary source tree that can be removed to construct an alternative source tree. Connectivity can then be checked by maintaining an adjacency matrix for the graph. Each node is capable of independently conducting this connectedness check based upon information received by adjacent nodes. Each node is also capable of broadcasting the connectivity data to any other node, and each node is therefore capable of multicast routing.

In still other embodiments, each device may receive, transmit, and/or consider multiple different metrics. That is, a first device might use SNR, while a second device uses bandwidth and delay. Over time these devices might stay with the same metrics or might change to use different metrics, which might be the same or different from those metrics used by other devices in the mesh network. Further the devices might apply different weighting to the metrics than the weightings use by other devices. Again, over time the devices might change the weightings given to the various metrics. These metrics and weightings might be changed or adjusted over time due, for example, to changes to the network environment and network conditions.

The systems and protocol described above may be implemented on one or more different systems, such as a general-purpose computer with sufficient processing power, memory resources, and network throughput capability to handle the necessary workload placed upon it. FIG. 5 illustrates a typical, general-purpose computer system suitable for implementing one or more embodiments disclosed herein, including operating as a node. The computer system 380 includes a processor 382 (which may be referred to as a central processor unit or CPU) that is in communication with memory devices including secondary storage 384, read only memory (ROM) 386, random access memory (RAM) 388, input/output (I/O) 390 devices, and network connectivity devices 392. The processor may be implemented as one or more CPU chips.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage. The RAM 388 is used to store volatile data and perhaps to store instructions. Access to both ROM 386 and RAM 388 is typically faster than to secondary storage 384.

I/O 390 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 392 may take the form of modems, modem banks, ethernet cards, universal serial bus (USB) interface cards, serial interfaces, token ring cards, fiber distributed data interface (FDDI) cards, wireless local area network (WLAN) cards, ultra-wideband (UWB) cards, radio transceiver cards such as code division multiple access (CDMA) and/or global system for mobile communications (GSM) radio transceiver cards, and other well-known network devices. These network connectivity 392 devices may enable the processor 382 to communicate with an Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and output to the network, for example, in the form of a computer data signal embodied in a carrier wave

Such information, which may include data or instructions to be executed using processor 382 for example, may be received from and outputted to the network, for example, in the form of a computer data baseband signal or signal embodied in a carrier wave. The baseband signal or signal embodied in the carrier wave generated by the network connectivity 392 devices may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 382 executes instructions, codes, computer programs, scripts which it accesses from hard disk, floppy disk, optical disk (these various disk based systems may all be considered secondary storage 384), ROM 386, RAM 388, or the network connectivity devices 392.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A method for updating nodes in a mesh network with routing information, comprising:
obtaining one or more metrics related to one or more adjacent links in the mesh network;
defining parameters that include weighting the one or more metrics to be used for routing that considers QoS in the mesh network; and
propagating routing information related to the parameterized metrics to one or more adjacent nodes in the mesh network.

2. The method of claim 1, wherein the parameters include a depth of a source tree information to be gathered.

3. The method of claim 1, further comprising:
computing, a primary route based on the parameterized metrics; and
computing one or more alternate routes

4. The method of claim 3, wherein the primary route identifies a route that would provide a higher quality of service (QoS) than the one or more alternate routes.

5. The method of claim 1, further comprising:
obtaining a plurality of metrics; and
weighting among the plurality of metrics.

6. The method of claim 1, wherein the metrics include signal-to-noise ratio, delay, jitter, bandwidth, hopcount, data rates, and other metrics that relate to QoS in the network.

7. The method of claim 6, wherein the metrics are not equally weighted.

8. The method of claim 6, wherein the metrics are equally weighted.

9. The method of claim 1, wherein only the routing information related to the parameterized metric is propagated to adjacent nodes.

10. A wireless device for routing data in a mesh network, comprising:
a component operable to obtain metrics related to one or more directly adjacent links in the mesh network and metrics received from one or more other nodes in the mesh network, the component operable to apply parameters that include weighting to one or more of the metrics to compute one or more routes for routing that considers QoS in the mesh network; and
a transmitter operable to propagate to one or more adjacent nodes in the mesh network at least the routing information related to the parameterized metrics obtained by the component.

11. The wireless device of claim 10, wherein the parameters include a depth of a source tree information to be gathered.

12. The wireless device of claim 10, wherein at least one of the computed routes would provide a higher quality of service (QoS) than an alternate computed route.

13. The wireless device of claim 10, wherein at least one of the computed routes would provide a higher quality of service (QoS) based on a particular service than an alternate computed route.

14. The wireless device of claim 10, wherein the component is operable to obtain a plurality of metrics, and wherein the component uses the parameters to weight the plurality of metrics for route determination.

15. The wireless device of claim 14, wherein one or more of the metrics and weightings change over time.

16. The wireless device of claim 10, wherein the metrics include signal-to-noise ratio, delay, jitter, bandwidth, hopcount, data rates, and other metrics that relate to QoS in the network.

17. The wireless device of claim 10, wherein the parameterized metrics received from one or more other nodes in the mesh network to compute one or more routes for routing data is further defined as data containing a complete network topology of all the nodes within the mesh network.

18. A component used by a wireless mesh point in a mesh network, comprising:
logic operable to execute a routing protocol that includes:
obtaining metrics for at least some links adjacent the wireless mesh point,
obtaining metrics related information for some other links in the mesh network,
publishing at least some of the metrics for the adjacent links to at least some adjacent mesh points, and
applying parameters to weight the metrics for the adjacent links and to weight the metrics related information for some of the other links to consider QoS in the mesh network.

19. The component of claim 18, wherein the routing protocol executable by the logic further includes computing a primary route and at least one alternate route, the primary routes providing an higher quality of service (QoS) than the alternate route.

20. The component of claim 18, wherein the routing protocol executable by the logic further includes using the parameterized metrics to determine routes base on quality of service (QoS).

21. The component of claim 18, wherein the metrics include signal-to-noise ratio, delay, jitter, bandwidth, hopcount, data rates, and other metrics that relate to QoS in the network.

22. The component of claim 18, wherein the routing is further defined as is further defined as link state routing, and wherein link state information about each node in the mesh network is provided.

23. The component of claim 18 wherein the logic is implemented using one item selected from the group consisting of circuitry, software, and firmware.
